(19) United States
(12) Patent Application Publication
(10) Pub. No.: US 2024/0059209 A1
(43) Pub. Date: Feb. 22, 2024

(54) VEHICLE TIE DOWN BRACKET

(71) Applicant: Quadratec, Inc., West Chester, PA (US)

(72) Inventors: Patrick W. BENNETT, Kennett Square, PA (US); Christopher M. HOWD, University Park, PA (US)

(73) Assignee: Quadratec, Inc., West Chester, PA (US)

(21) Appl. No.: 17/820,394

(22) Filed: Aug. 17, 2022

(51) Int. Cl. B60P 7/08

(52) U.S. Cl. CPC B60P 7/0807

(57) ABSTRACT

An apparatus is for attaching a tie down to a vehicle, wherein the tie down is adapted for securing a roof object to the vehicle. The apparatus comprises a substrate; at least one mounting member adapted for attaching the substrate to the vehicle; a catch coupled to the substrate, the catch adapted for attachment to the tie down; and a door that prevents attaching the tie down to the catch when the door is closed, and that provides the tie down with access to the catch when the door is open.

### FIELD OF THE INVENTION

The present invention relates to tie down brackets and in particular to tie down brackets that accept tie downs for use with vehicles. Specifically, an apparatus and method are described that includes a tie down bracket with a door for use with vehicles.

### BACKGROUND OF THE INVENTION

While vehicles are a ubiquitous form of transportation, it may be desired to use a vehicle for moving objects that cannot be accommodated in the vehicle interior. For this reason, tie down brackets are known. A tie down bracket may exist at multiple locations on the exterior of a vehicle. Using a tie down (an elongated object, such as a rope or strap, for attaching a further object to a vehicle), it is possible to affix an object to the outside of the vehicle. The tie down extends between the tie down bracket and the object being affixed to the vehicle. In this way, the object is safely held in place while the vehicle is driven to its destination.

One application of tie down brackets is to enable objects to be affixed to the roof of a vehicle. An exemplary tie down bracket is described in U.S. Pat. No. 10,759,330 which is hereby incorporated by reference in its entirety. A similar tie down bracket is illustrated in FIG. 1, but without the lighting disclosed in the aforementioned patent. FIG. 1 is a prior art perspective drawing that illustrates an exemplary method of attaching roof objects 150 to vehicle 105. In FIG. 1, vehicle 105 is illustrated. Vehicle 105 includes roof 120, hood 110, grill 115, and fender 112. Tie down bracket 130 is affixed to vehicle 105 between hood 110 and fender 112. Roof rack 125 is attached to roof 120. Roof objects 150 are attached to vehicle 105 via tie down 140. In particular, in FIG. 1, tie down 140 is shown extending through opening 135 in tie down bracket 130, engaging roof object 150, and secured to roof rack 125. FIG. 1 shows numerous objects attached to roof rack 125, but this is merely exemplary. In the configuration shown in FIG. 1, vehicle 105 can be driven and roof objects 150 are maintained in a stationary position on top of roof 120.

FIG. 2 is a further prior art drawing that illustrates tie down bracket 130 in a close-up and perspective view. FIG. 2 illustrates tie down bracket 130 prior to attachment to vehicle 105. Tie down bracket 130 includes base 210 and a protrusion that extends in an orthogonal direction upward from base 210. A variety of materials may be used in the fabrication of base 210 and protrusion 215. Exemplary materials include metals and resins. Base 210 and protrusion 215 may be comprised of the same material or may be comprised of a different material. Extending downward from base 210 are mounting members 235. Mounting members 235 enable tie down bracket 130 to be attached to fender 112, hood 110, or some other portion (such as an internal portion not seen in FIG. 1) of vehicle 105. A variety of mounting members may be used for attaching tie down bracket 130 to vehicle 105. As shown in FIG. 2, mounting members 235 may be threaded members (metal or plastic), friction type members, or openings to accommodate corresponding bolts. Tie down bracket 130 includes an opening in which is placed insert 220. Insert 220 may be held in place via attachment members 225. Insert 220 may, for example, be formed of a material stronger than the material used in protrusion 215. Insert 220 includes opening 230. Tie down 140 is inserted into opening 230.

FIG. 3 is a further perspective view of tie down bracket 130 is shown in FIG. 2.

FIG. 4 is a further perspective view of tie down bracket 130 shown in FIG. 1, FIG. 2, and FIG. 3.

### SUMMARY OF THE INVENTION

An apparatus is for attaching a tie down to a vehicle, wherein the tie down is adapted for securing a roof object to the vehicle. The apparatus comprises a substrate; at least one mounting member adapted for attaching the substrate to the vehicle; a catch coupled to the substrate, the catch adapted for attachment to the tie down; and a door that prevents the tie down from accessing the catch when the door is closed, and that provides the tie down with access to the catch when the door is open.

### BRIEF DESCRIPTION OF THE DRAWINGS

FIG. 1 is a perspective drawing of a vehicle with tie downs to secure one or more objects to a vehicle roof in accordance with the prior art.

FIG. 2 is a perspective drawing of a vehicle tie down bracket in accordance with the prior art.

FIG. 3 is a perspective drawing of a vehicle tie down bracket in accordance with the prior art.

FIG. 4 is a perspective drawing of a vehicle tie down bracket in accordance with the prior art.

FIG. 5A and FIG. 5B are perspective drawings of a vehicle tie down bracket (or recessed member) in a closed and open configuration, respectively, in accordance with an exemplary embodiment of the present invention.

FIG. 5C is a further perspective drawing in the bracket shown in FIGS. 5A and 5B, but with a tie down coupled thereto.

FIG. 5D is a cross-sectional view of the bracket illustrated in FIG. 5C.

FIG. 6 is a perspective view of a vehicle in combination with the bracket illustrated in FIG. 5C.

FIG. 7A and FIG. 7B are perspective drawings of a vehicle tie down bracket (or recessed member) in a closed and open configuration, respectively, in accordance with an exemplary embodiment of the present invention.

FIG. 8A and FIG. 8B are perspective drawings of a vehicle tie down bracket (or recessed member) in a closed and open configuration, respectively, in accordance with an exemplary embodiment of the present invention.

FIG. 9A and FIG. 9B are perspective drawings of a vehicle tie down bracket (or recessed member) in a closed and open configuration, respectively, in accordance with an exemplary embodiment of the present invention.

FIG. 10A is a perspective drawing of a vehicle tie down bracket (or recessed member) in accordance with an exemplary embodiment of the present invention.

FIG. 10B and FIG. 10C are respective side and end views of the vehicle tie down bracket illustrated in FIG. 10A.

FIG. 11A is a perspective drawing of a vehicle tie down bracket (or recessed member) in accordance with an exemplary embodiment of the present invention.

FIG. 11B is a perspective drawing of a vehicle tie down bracket (or recessed member) in accordance with an exemplary embodiment of the present invention.

FIG. 12 is a perspective drawing of a vehicle tie down bracket (or recessed member) in accordance with an exemplary embodiment of the present invention.

### DETAILED DESCRIPTION

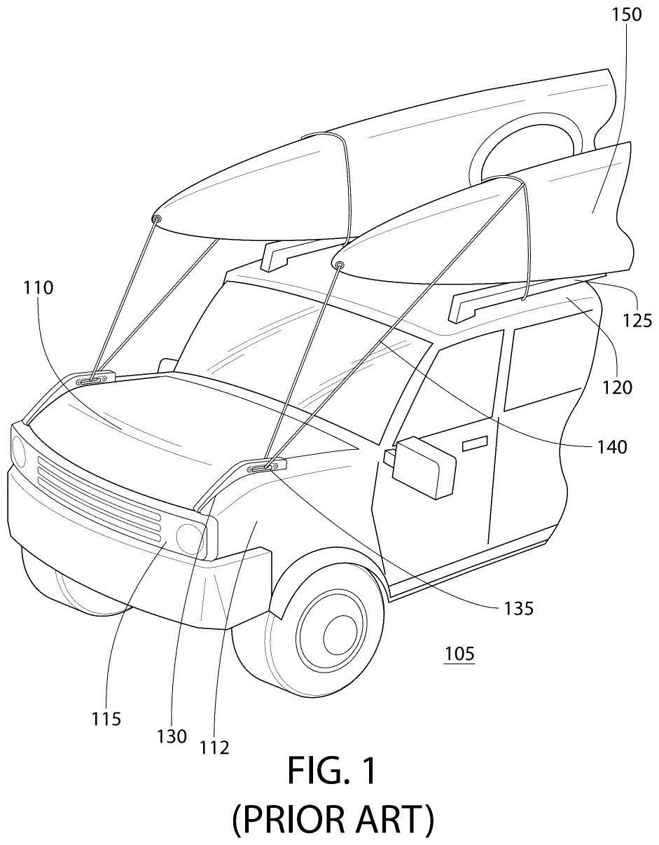

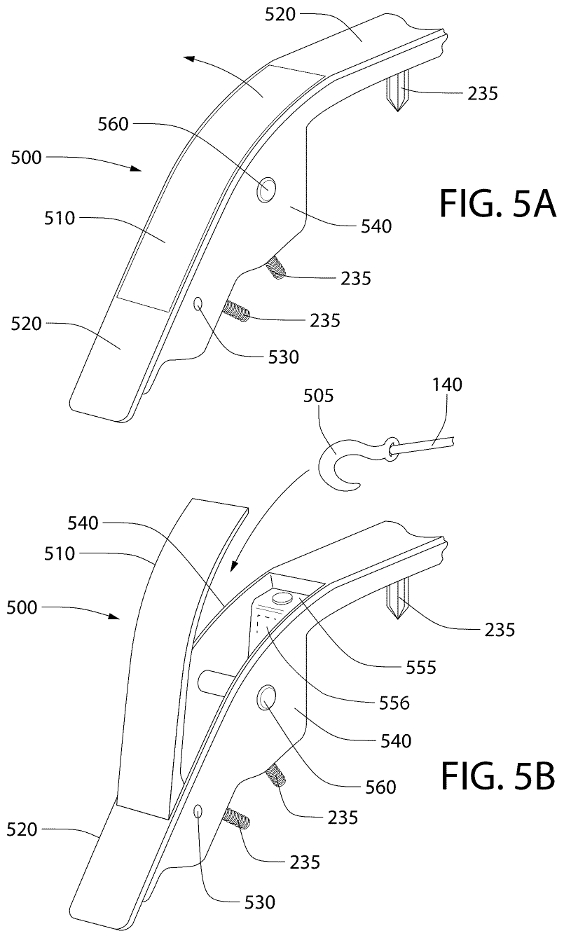

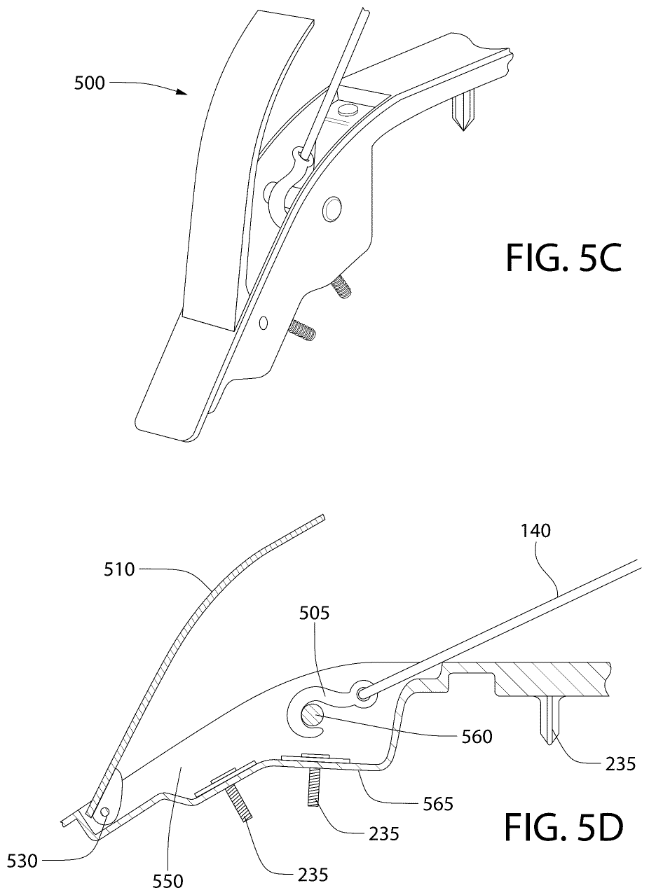

FIG. 5A and FIG. 5B illustrate recessed member 500 in accordance with an exemplary embodiment of the present invention. Recessed member 500 is able to perform similar functions as may be performed by tie down bracket 130. However, recessed member 500 provides advantages that are not achieved by tie down bracket 130. In particular, as shown in FIG. 1, tie down bracket 130 protrudes above the top surface of hood 110 and/or fender 112. By contrast, as shown in FIG. 6, a top surface of recessed member 500 conforms with the top surface of hood 110 and/or fender 112. In some embodiments, recessed member 500 may only protrude above hood 110 and/or fender 112 while recessed member 500 is being used in combination with a tie down. When not in use, for example, door 510 of recessed member 500 is closed, and the top surface of door 510 conforms with the top surface of hood 110 and/or fender 112. When in use, however, door 510 may be open and protrude above the top surface of hood 110 and/or fender 112.

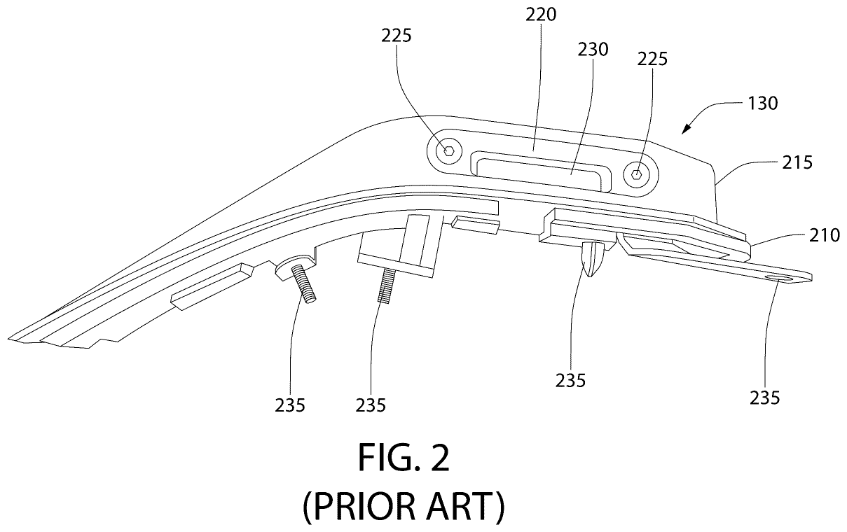

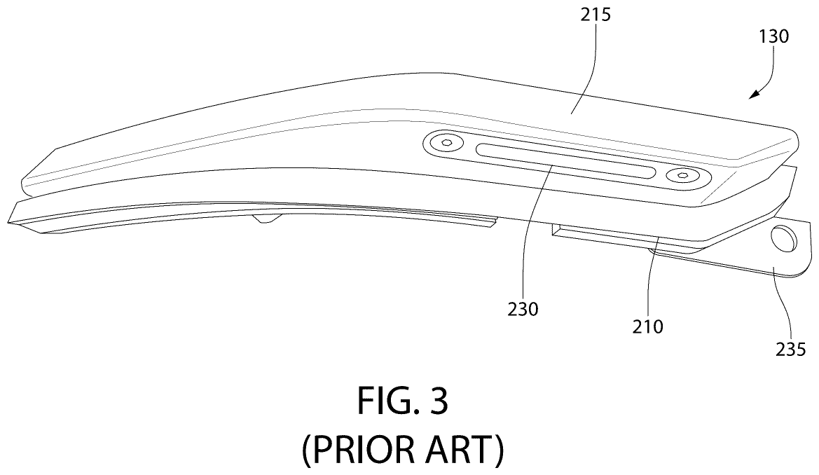

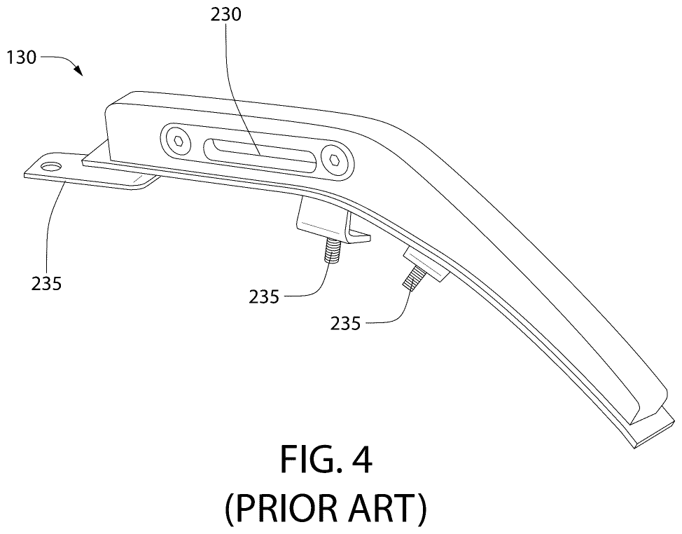

As shown in FIG. 5A, recessed member 500 includes substrate 540. Substrate 540 may include, for example, two opposing walls (and optionally a bottom) as shown in FIG. 5B. Alternatively, substrate 540 may be comprised of one wall and a bottom. Recessed member 500 includes catch 560. Catch 560 may be, for example, a sturdy metal pin that extends across recessed member 500. Catch 560 may be located within recessed member 500 with sufficient space below catch 560 to enable hook 505 to engage catch 560. Door 510 is included and door 510 may be closed when recessed member 500 is not in use. Door 510 may be attached to recessed member 500 via hinge 530 (although other structures to achieve attachment may be used). Extending from the bottom of substrate 540, a plurality of mounting members 235 may be used for attaching recessed member 500 to a vehicle. Similarly to mounting members 235 shown in FIG. 2, mounting members 235 shown in FIG. 5A may be a plurality of different structures including threaded members, friction holds, openings for receiving bolts, etc. In one or more exemplary embodiments, recessed member 500 is comprised of a substrate 540, mounting member 235 for securing substrate 540 to the vehicle, and catch 560 (described below) that is coupled to substrate 540 and that couples to tie down 140. In one exemplary embodiment of the present invention, the location of mounting members 235 shown in FIG. 5A are located in the same positions as mounting members 235 shown in FIG. 2. Alternatively, or for clarification, the location of mounting members 235 may be in the same positions as the corresponding structures illustrated in U.S. Pat. No. 10,759,330. In this manner, tie down bracket 130 may be removed and replaced with recessed member 500.

In a further exemplary embodiment of the present invention, catch 560 is replaced with catch 556. Catch 556 may be, for example, an opening that is formed in substrate 540. Thus, hook 505 may be inserted into catch 556 by being inserted into the corresponding opening. In this embodiment, the catch is “coupled” to the substrate by being formed as an opening in the substrate.

When recessed member 500 is not being used to tie down an object, door 510 may be in a closed position as it appears in FIG. 5A. There are a variety of mechanisms by which door 510 may be maintained in the closed position illustrated in FIG. 5A. In one embodiment, door 510 rotates about hinge 530 but is maintained in the closed position by virtue of the weight of door 510. In another embodiment, hinge 530 is a spring hinge that urges door 510 into the closed position illustrated in FIG. 5A. In a further embodiment, an alternative mechanism is used to keep door 510 closed. Exemplary mechanisms include the use of magnetic attraction, the use of “hook and loop” closure, the use of friction, a deformable (or spring-loaded) tab located at one or more peripheral portions of door 510, etc.

FIG. 5B illustrates recessed member 500 when it is being used for the purpose of tying down an object to a vehicle. In FIG. 5B, door 510 is in an open position compared to the position illustrated in FIG. 5A. The position illustrated in FIG. 5B may be obtained, in one exemplary embodiment, by rotating door 510 about hinge 530 and thus providing access to catch 560. When access to catch 560 is provided, tie down 140 is capable of transitioning from a state in which tie down 140 is not coupled to catch 560, to a state in which tie down 140 is coupled to catch 560. When tie down 140 transitions as stated above, tie down 140 goes through the process of attaching to catch 560. Conversely, when access to catch 560 is not provided, tie down 140 is unable to transition from a state in which tie down 140 is not coupled to catch 560, to a state in which tie down 140 is coupled to catch 560. Illustrated rotation may be accomplished, for example, by pressing down on door 510 near the bottom-most portion of door 510 (from the perspective illustrated in FIG. 5B). Alternatively, a small gap may be included towards the top most portion of door 510 (from the perspective illustrated in FIG. 5B) such that a human finger or fingernail can be inserted into the gap to effectively pry door 510 from the position shown in FIG. 5A to the position shown in FIG. 5B. In yet another embodiment, a small protrusion may be included in door 510 (extending for example orthogonally upward from the outward surface shown in FIG. 5B) so that door 510 can be pulled open with human fingers. In yet another embodiment, a small space can be introduced into a sidewall of substrate 540 to enable room for a tool or human finger to pull door 510 upwards. The above disclosed structures for enabling door 510 to be pulled upwards are exemplary and it is understood to a person of ordinary skill in the art reviewing the current specification that other structural elements may be used to enable door 510 to be transitioned upwards.

In the configuration shown in FIG. 5B, door 510 is open thereby exposing the interior of recessed member 500 (and thus exposing catch 560). In accordance with an exemplary embodiment of the present invention, catch 560 may extend at least partially across substrate 540. Catch 560 provides a surface that extends substantially along a horizontal axis within recessed member 500. In one embodiment, catch 560 extends between opposite side walls (i.e. if substrate 540 is comprised of opposing walls). In another embodiment, catch 560 may extend from a bottom surface of recessed member 500. In such an embodiment, for example, catch 560 may have the configuration of an upside down “U” or may have the configuration of an upside down “U” with a flattened midsection. In a further embodiment, catch 560 may extend partially from a sidewall of substrate 540 and may extend partially from a bottom surface of recessed member 500.

As shown, catch 560 is mounted within recessed member 500 with sufficient strength to stay in place when securing an object to vehicle 105 via tie down 140. Depending upon the weight of roof object 150, catch 560 may be desirably installed with sufficient strength to stay in place. Thus, for example, catch 560 may be secured to substrate 540 via rivets, bolts, nuts, friction holds, or other attachment means.

Stop 555 may also optionally be included. Stop 555 may include a surface on which door 510 sits when in the closed position illustrated in FIG. 5A. In one or more alternative embodiments of the present invention, stop 555 may include a mechanism to hold door 510 in place when in the configuration shown in FIG. 5A. Such a mechanism may include a magnet, structure that provides frictional holds, hook-and-loop attachment, etc.

In the configuration shown in FIG. 5B, tie down 140 includes hook 505. Hook 505 engages catch 560 in order to secure tie down 140 to recessed member 500.

FIG. 5C is a perspective view that illustrates tie down 140 secured to catch 560 via hook 505. In FIG. 5C, it is shown that door 510 may remain in an open position and simply rest upon tie down 140 when tie down 140 is attached to recessed member 500. In a further exemplary embodiment of the present invention, door 510 may include a slot (not shown) through which tie down 140 extends when door 510 is in a closed position. In such an embodiment, access to catch 560 may initially be prevented until door 510 is opened. Opening door 510 may provide tie down 140 with access to catch 560. After achieving access and coupling tie down 140 to catch 560, door 510 may then be closed.

FIG. 5D is a cross sectional view that allows visualization of the interior of recessed member 500. In FIG. 5D, door 510 is in the open position shown in FIG. 5C. In FIG. 5D, the placement of hook 505 about catch 560 is shown. While door 510 is shown at approximately a 45 degree angle, this is merely for illustrative purposes as door 510 can be in any orientation about hinge 530. As an example, door 510 may rest with downward force caused by gravity so that it simply rests on hook 505 or tie down 140. While catch 560 is shown as a linear member, this is merely exemplary. Tie down 140 extends from roof object 150 (not shown in FIG. 5D).

Thus, in accordance with an exemplary embodiment of the present invention, the recessed member 500 may be in an initial state in which door 510 is in a “down” or “closed” position and tie down 140 is not coupled to recessed member 500 (via, for example, catch 560). This is a “no access” configuration. Door 510 is subsequently opened so that catch 560 may be accessed for being coupled to tie down 140. After tie down 140 is coupled to catch 560, door 510 may be lowered (in some embodiments). In one exemplary embodiment, a slot may be included in door 510 so that 510 is closed, and tie down 140 extends through the slot in order to engage catch 560. In another exemplary embodiment, door 510 is transitioned from an open position to a “less open” position after tie down 140 is coupled to catch 560. Thus, tie down 140 may be prevented from coupling to (accessing) catch 560 when door 510 is closed, but after door 510 is open, tie down 140 is then able to access (and be coupled to) catch 560.

FIG. 6 is a perspective drawing that illustrates recessed member 500 on both sides of the front of the vehicle 105, with tie downs coupled to each recessed member 500, and the tie downs securing objects to the vehicle roof.

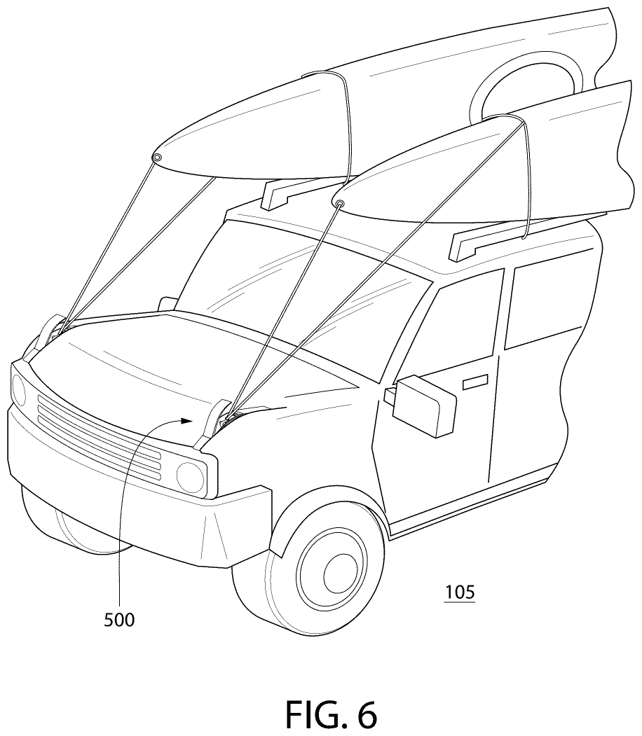

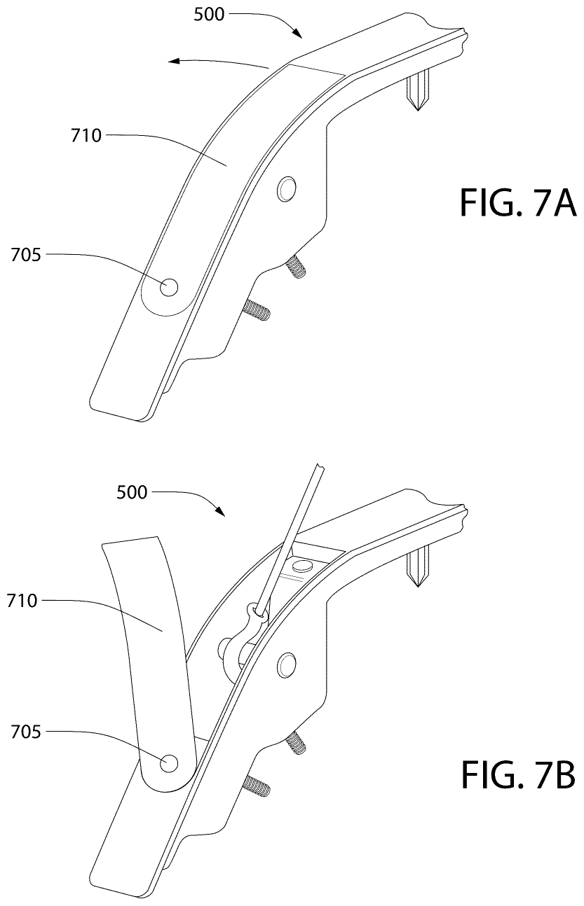

FIG. 7A is a perspective view of recessed member 500 in accordance with a further exemplary embodiment of the present invention. FIG. 7A includes door 710 in place of door 510 and pivot 705 in place of hinge 530. As can be seen in FIGS. 7A and 7B, door 710 pivots about pivot 705 along an axis that is orthogonal to the axis that extends through hinge 530. In other words, instead of door 510 that pivots up and down, door 710 pivots from side to side. It is understood that door 510 and door 710 are merely examples of how a door can pivot in place and out of place to cover and uncover the interior of door 500. In some embodiments, door 710 may include some flexibility so it can move between the positions shown in FIG. 7A and FIG. 7B. In FIG. 7B, door 710 is in an open position so that tie down 140 may be coupled to catch 560.

In the exemplary embodiments, recessed member 500 (and/or parts thereof) may comprised of materials having sufficient strength for the being secured to a vehicle, engaging a tie-down, and staying in place after the tie-down has been coupled to recessed member 500. Exemplary materials include metals (aluminum, stainless steel, etc.) and resins. In various embodiments, the door can be made of the same or different materials than are used to manufacture the remainder of recessed member 500.

In the embodiments illustrated in FIGS. 5C and 7B, hinge 530 and/or pivot 705 may provide simple pivoting, or may provide pivoting in combination with another function. For example, hinge 530 or pivot 705 may be spring loaded (or spring loaded like) in order to urge door 510/710 into a closed position. In some embodiments, door 510/710 may include optional “stops” in order to maintain door 510/710 in either a closed position, an open position, a partially open position, etc. Other exemplary structures may be used to maintain or urge door 510/710 into open and/or closed positions.

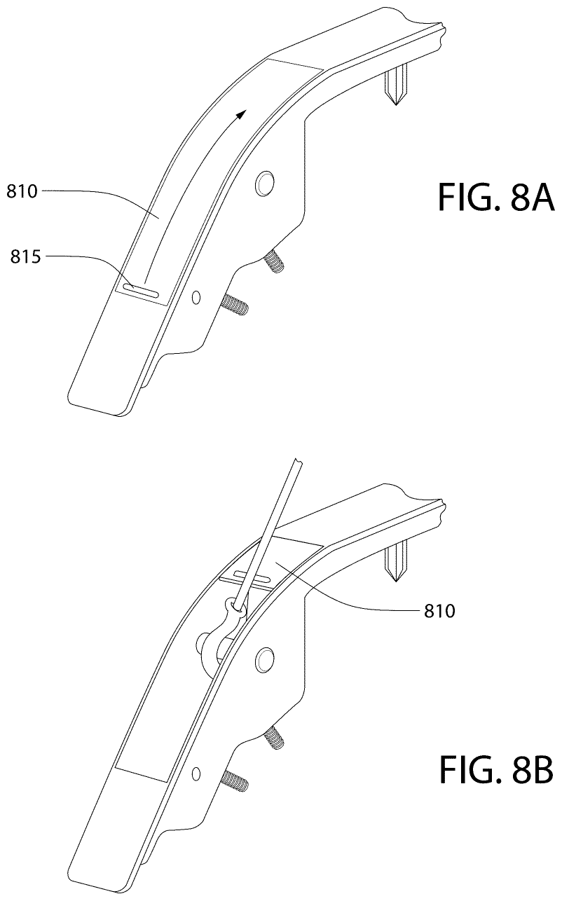

FIG. 8A illustrates yet another exemplary embodiment of the present invention. In FIG. 8A, door 810 is a “pocket door” that slides upwards to reveal the interior of recessed member 500. By sliding door 810 upwards into a “pocket” (not shown) within recessed member 500, the interior of recessed member 500 is exposed so that tie down 140 may be coupled to catch 560, as is illustrated in FIG. 8B. The configuration shown in FIG. 8A is merely exemplary. For example, door 810 may slide downward into a “pocket” to reveal the interior of recessed member 500. Optional tab 815 may be included to facilitate the sliding of door 810 between a closed position and an open position. Tab 815 may be a projection extending above the top surface of door 810. Tab 815 may alternatively (or in addition) be an indentation or opening extending below the top surface of door 810.

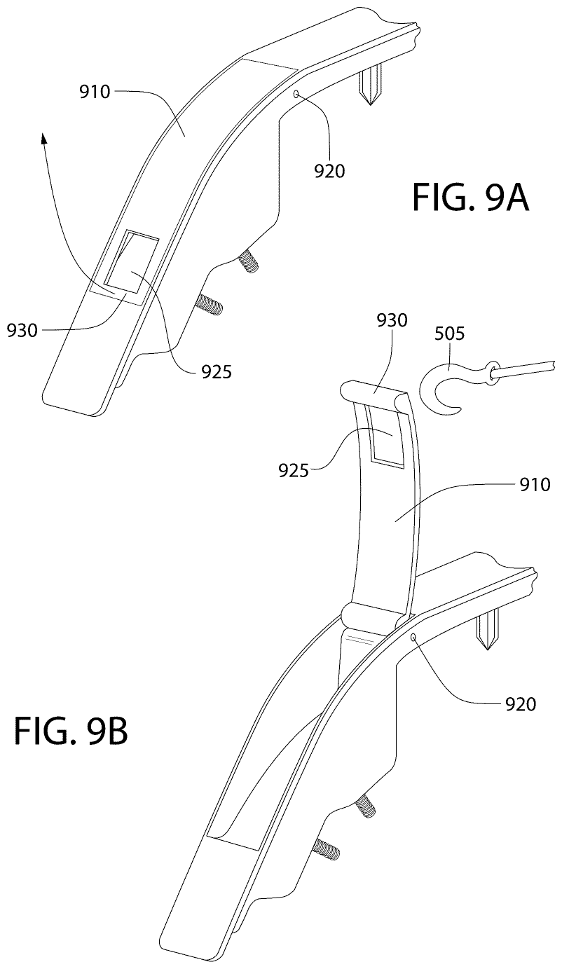

FIG. 9A illustrates yet another exemplary embodiment of the present invention. In the embodiment illustrated in FIG. 9A, catch 930 has been attached to door 910. Door 910 includes opening 925 that at least partially defines catch 930. Door 910 pivots about hinge 920 to achieve the open configuration shown in FIG. 9B. When door 910 is open, catch 930 is available for engagement by hook 505 (attached for example to tie down 140).

As with catch 560, catch 930 is desirably formed with sufficient strength to maintain hook 505 in place. In one example, catch 930 (or catch 560) is formed with sufficient strength to withstand a load of 500 pounds. Catch 930 (or catch 560) may be formed with different loading ratings depending upon the anticipated/desired application.

In accordance with other embodiments, hinge 920 may include a spring (or spring-like member) to be urged into a closed configuration. The location of hinge 920 is also exemplary, as hinge 920 may alternatively be placed towards the lower end of member 500 (as opposed to being towards the upper end of member 500 in the view that appears in FIGS. 9A and 9B.

The above examples illustrate how a door may be included with recessed member 500 to cover the interior of recessed member 500 while, for example, recessed member 500 is not being used in combination with tie down 140. The various described embodiments are merely exemplary as it is understood that the motion of the door relative to the remainder of recessed member 500 may be other than what was specifically described. While the above examples have described pivoting or sliding, it is understood that the motion of the door relative to the remainder of member 500 can be in any one or more of six degrees of motion. All forms of motion may be included therein, including translational motion (rectilinear motion, curvilinear motion, or a combination thereof), rotational motion, combinations thereof, etc. As a further example, the door may be detachable from the remainder of recessed member 500. In such an embodiment, a mechanism is desirably included to secure the door to the remainder of member 500.

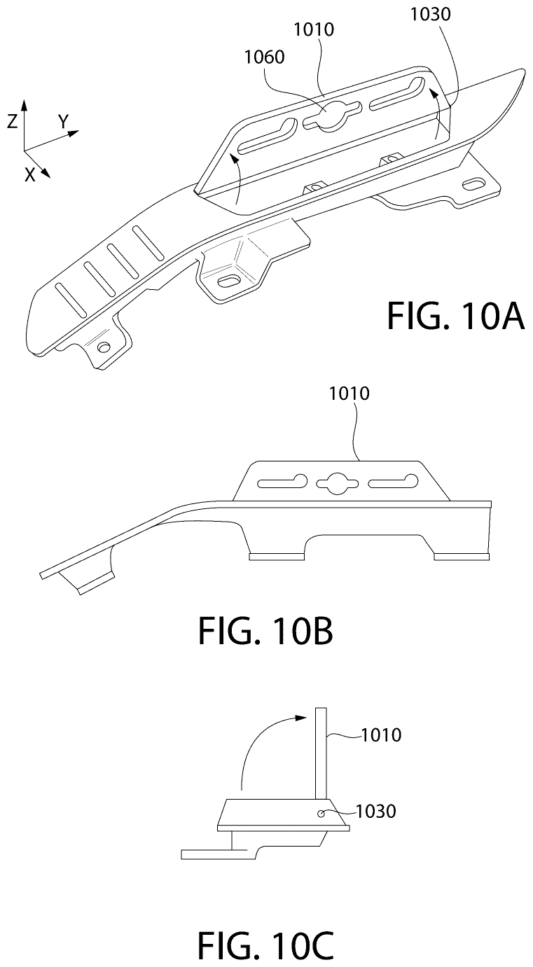

Examples of further alternative embodiments in accordance with various forms of motion of a door are illustrated in FIGS. 10A-10C, 11A, 11B, and 12. In contrast with the orientation of hinge 530 of FIG. 5A and FIG. 5B, hinge 1030 is substantially perpendicular to hinge 530. In FIG. 10A, instead of hinge 530 that pivots door 510 about an x-axis, hinge 1030 pivots door 1010 about a y-axis perpendicular to the x-axis. In the embodiment shown in FIG. 10A, a hinge (not shown) may be located below door 1010, and may become accessible to tie down 140 when door 1010 is transitioned from a closed configuration to the open configuration shown in FIG. 10A. As an alternative, catch 1060 may be integrated into door 1010, so that catch 1060 is available for coupling to tie down 140 when door 1010 is placed into the configuration shown in FIG. 10A. As a further alternative, door 1010 may include a slot so that, after tie down 140 is coupled to the catch included with the embodiment illustrated in FIG. 10A (either integrated with door 1010 or located below door 1010 when door 1010 is closed), door 1010 may be closed.

As with other embodiments, various mechanisms may keep door 1010 in a closed configuration, including the weight of door 1010, a magnetic coupling, frictional force, hook-and-loop technology, etc.

FIG. 10B illustrates the embodiment shown in FIG. 10A from a side view. FIG. 10C illustrates the embodiment shown in FIG. 10A from an end view.

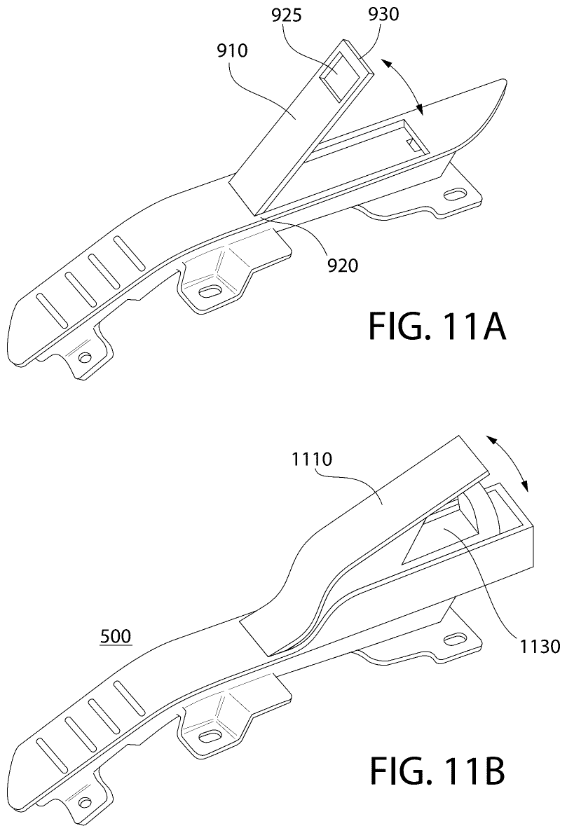

FIG. 11A illustrates an embodiment similar to the embodiment shown in FIG. 9A, except pivot 920 has been moved from a location near the top of door 910 to a location near the bottom of door 910. Catch 930 may again be integrated into door 910 as a result of being defined by opening 925.

FIG. 11B illustrates a further exemplary embodiment in which catch 1130 is integrated into door 1110 and catch 1130 is situated below door 1110. Door 1110 may be coupled to recessed member 500 by virtue of a hinge (not shown) that enables door 1110 to pivot between open and closed positions as illustrated in FIG. 11B. In one embodiment, door 1110 may be pulled open via a tab, fingernail slot, etc. to attain the configuration shown in FIG. 11B. In another embodiment, door 1110 may include a spring-loaded latch (not shown), so that depressing door 1110 causes door 1110 to spring upward, and so that subsequent depressing of door 1110 causes door 1110 to lock into a closed configuration.

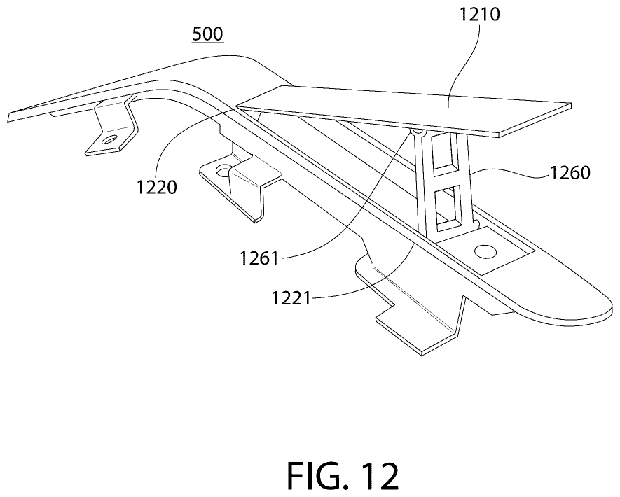

FIG. 12 illustrates a further exemplary embodiment of the present invention in which catch 1260 becomes accessible to tie down 140 when door 1210 is opened. As an example, door 1210 may open by pivoting about hinge 1220. As door 1210 transitions from a closed configuration to an open configuration, catch 1260 can transition from a position inaccessible to tied down 140 to (for example) the position illustrated in FIG. 12. In one example, end 1261 may slide (for example in a track) along the underside of door 1210 so that door 1210 transitions into the position shown in FIG. 12. In such an example, the upward force of door 1210 causes catch 1260 to move into the illustrated position. In another example, hinge 1221 is spring loaded, so that when door 1210 is opened, catch 1260 effectively “pops up” into the illustrated configuration. When door 1210 is lowered, door 1210 may be maintained in the lowered position by using various exemplary mechanisms, including for example the weight of door 1210, spring (or spring-like) sources of force, magnetics, friction, hook and loop, etc.

The above referenced figures are again exemplary of door motion and catch access. Other forms of door motion and catch access are also contemplated.

In each of the exemplary embodiments, one or more mechanisms may be included to maintain the door in one or more of various configurations relative to the remainder of member 500. Such configurations include closed, open, attached, detached, etc. Mechanisms may include springs (or spring-like members) to urge the door into one or more configurations, magnets to hold the door into one or more configurations, frictional members, mechanical locking members, temporary attachment members (such as hook-and-loop materials), etc. The above list is merely exemplary.

Recessed member 500 may be attached to a vehicle in various manners, using for example mounting members 235 attached to recessed member 500. Exemplary points of contact between recessed member 500 and the vehicle include the hood, the fenders, or another point of contact.

While various exemplary embodiments have been described, it is understood that embodiments may be combined. Also, aspects of one embodiment may be combined with aspects of another embodiment.

Whereas many alterations and modifications of the disclosure doubt become apparent to a person of ordinary skill in the art after having read the foregoing description, it is to be understood that any particular implementation shown and described by way of illustration is in no way intended to be considered limiting. Therefore, references to details of various implementations are not intended to limit the scope of the claims, which in themselves recite only those features regarded as the disclosure.

### PARTS LIST

105 Vehicle
110 Hood
112 Fender
115 Grill
120 Roof
125 Roof Rack
130 Tie Down Bracket
135 Opening
140 Tie Down
150 Roof Object
210 Base
215 Protrusion
220 Insert
225 Attachment Member
230 Opening
235 Mounting Member
500 Recessed Member
505 Hook
510 Door
520 Exterior Panel
530 Hinge
540 Substrate
550 Interior
555 Stop
560 Catch
705 Pivot
710 Door
810 Door
815 Tab
910 Door
920 Hinge
925 Opening
930 Catch

1. Apparatus for attaching a tie down to a vehicle, wherein said tie down is adapted for securing a roof object to said vehicle, said apparatus comprising:
a substrate;
at least one mounting member adapted for attaching said substrate to said vehicle;
a catch coupled to said substrate, said catch adapted for attachment to said tie down;
a door that prevents said tie down from attaching to said catch when said door is closed, and that provides said tie down with access to said catch when said door is open.

2. Apparatus according to claim 1, wherein said substrate includes two opposing walls, and said catch extends between said two opposing walls.

3. Apparatus according to claim 1, wherein said catch is attached to said door.

4. Apparatus according to claim 1, wherein said door is attached to said substrate with a hinge along an edge of said door.

5. Apparatus according to claim 1, wherein said door is attached to said substrate with a pivot member having an axis of ration orthogonal to a surface of said door.

6. Apparatus according to claim 1, wherein said door is attached to and subsequently separates from said substrate.

7. Apparatus according to claim 1, wherein said catch is integrated into and below a top surface of said door when said door is in a closed position.

8. Apparatus according to claim 1, wherein said door is above said mounting member and said catch is below said door.

9. Apparatus according to claim 1, wherein said door transitions between a closed state in which said catch is inaccessible to said tie down to an open state in which said catch is accessible to said tie down.

10. Apparatus according to claim 1, wherein said mounting member is attached to one of a front fender and a front hood of said vehicle.

11. A method of attaching a tie down to a vehicle, wherein said tie down is adapted for securing a roof object to said vehicle, said method comprising the steps of:
opening a door coupled to a substrate that is attached to the vehicle via at least one mounting member, wherein a catch is coupled to the substrate, the door prevents attaching said tie down to the catch when the door is closed, and the door when open permits the tie down to access the catch;
while maintaining the door open, attaching the tie down to the catch.

12. A method according to claim 11, wherein said substrate includes two opposing walls, and said catch extends between said two opposing walls.

13. A method according to claim 11, wherein said catch is attached to said door.

14. A method according to claim 11, wherein said door is attached to said substrate with a hinge along an edge of said door.

15. A method according to claim 11, wherein said door is attached to said substrate with a pivot member having an axis of ration orthogonal to a surface of said door.

16. A method according to claim 11, wherein said door is attached to and subsequently separates from said substrate.

17. A method according to claim 11, wherein said catch is integrated into and below a top surface of said door when said door is in a closed position.

18. A method according to claim 11, wherein said door is above said mounting member and said catch is below said door.

19. A method according to claim 11, wherein said door transitions between a closed state in which said catch is inaccessible to said tie down to an open state in which said catch is accessible to said tie down.

20. A method according to claim 11, wherein said mounting member is attached to one of a front fender and a front hood of said vehicle.
